(19) United States
(12) Patent Application Publication
(10) Pub. No.: US 2009/0041468 A1
(43) Pub. Date: Feb. 12, 2009

(54) METHOD FOR RECOVERING DISTORTED OPTICAL SIGNAL BY EQUALIZING UNIT

(75) Inventor: Takatoshi KATO, Kanagawa (JP)

Correspondence Address: VENABLE LLP, P.O. BOX 34385, WASHINGTON, DC, 20043-9998, US

(73) Assignee: SUMITOMO ELECTRIC INDUSTRIES, LTD., Osaka (JP)

(21) Appl. No.: 12/185,896

(22) Filed: Aug. 5, 2008

(30) Foreign Application Priority Data
Aug. 6, 2007 (JP) 2007-204317

(51) Int. Cl. H04B 10/04; H04L 27/01

(52) U.S. Cl. 398/137; 375/232

(57) ABSTRACT

A method for appropriately equalizing a distorted optical signal due to the dispersion of the optical fiber is disclosed. The equalizer unit in an optical transceiver firstly equalizes a test signal with clock period longer than an original clock period to determine a set of tap coefficients. Secondly, the equalizer unit sets thus obtained tap coefficients as the initial condition thereof, and lastly receives the original transmitting signal with distortions to equalize and to adjust the tap coefficients such that the original data contained in the transmitting signal may recover.

### BACKGROUND OF THE INVENTION

1. Field of the Invention

The present invention relates to an optical transceiver that transmits and receives optical signals, in particular, the invention relates to a method to equalize a distorted signal due to the dispersion of an optical fiber coupled with the transceiver.

2. Related Prior Art

The optical communication system is, in a word, to transmit an optical signal output from the transmitter in an optical fiber and to receive the optical signal by a receiver, where a large capacity of information may be transmitted/received in high speed. Such an optical communication system usually applies an optical transceiver with both the transmitter and the receiver.

One type of the optical communication system, where a haul to the next communication terminal is relatively short, for instance shorted than a few kilometers and a transmission speed thereof is relatively slow, for instance, less than a few hundred of mega-bps, uses multi-mode fibers as a transmission medium and light-emitting diodes (LED) as an optical signal source. On the other hand, the other type of the optical communication system, where the haul to the next terminal is long and the transmission speed exceeds a gigahertz, uses single mode fibers as the transmission medium and a semiconductor laser diode (LD) as the optical signal source, while a photodiode as the light-receiving device.

One international standard regarding the optical communication system with the transmission distance of 2 km and the transmission speed of 125 Mbps rules an optical fiber as the transmission medium having a core diameter of 62.5 μm and a graded index profile of the refractive index in the core. Another international standard for the communication system with the transmission speed of 622 Mbps, 2.5 Gbps and 10 Gbps, which is often called as the synchronous digital hierarchy (SDH) defines the signal mode fiber and the LD as the transmission medium and the signal source, respectively.

Recently, it is evaluated as the data capacity to be transmitted rapidly increases, whether the existing multimode fiber is applicable in the high speed communication using the LD as the optical signal source or not? The multimode fiber, because of its large core diameter, may effectively couple with the optical source and may suppress the large coupling loss even the optical misalignment between the fiber and the source occurs, which may relax the condition of the optical connector and may also reduce the cost of the optical system. However, the multimode fiber may transmit a plurality of optical modes and each optical mode shows different transmission speed, which easily deforms the optical signal and is hard to transmit high speed signals. This phenomenon is generally called as the dispersion of the optical fiber.

Several techniques are well known to compensate the dispersion described above. Winters; J. H. et. al, and Pepeljugoski; P. et. al have disclosed in IEEE transactions on Communications, vol. 38(9), pages 1439-1543 (1990) and Technical Digest of Optical Fiber Conference, No. ThG4, (2003), respectively, a method where the receiver equalizes an electrical signal converted from a received optical signal. The equalizer disclosed therein is a type of digital filters, often called as a transversal filter. The equalizer in the receiver enables the transceiver to be applied in the transmission speed of 10 Gbps. This equalizer is often called as the dispersion compensator.

### SUMMARY OF THE INVENTION

One aspect of the present invention relates to a method to equalize, by an equalizer unit, a distorted signal transmitted through an optical fiber with dispersion. The method comprises steps of: (a) providing a dummy signal with a clock cycle of k times T seconds to the equalizer unit; (b) equalizing the dummy signal to obtain a set of tap coefficients of the equalizer unit; and (c) equalizing the distorted signal as the tap coefficients obtained in step (b) as an initial set of tap coefficients.

The equalizer unit may include a feed forward block and a feedback unit. In the step (b) to equalizing the dummy signal, the equalizing unit sets, as an initial condition of the tap coefficients, one of tap coefficients of the feed forward block to 1, while, rests of tap coefficients of the feed forward unit and all of tap coefficients of the feedback unit are set to 0

Because the tap coefficients of the equalizer unit are initially set using the dummy signal with the clock cycle longer than the clock cycle of the signal to be practically equalized, the equalizer unit initially shows an enhanced response in high frequencies. Accordingly, even the signal is extremely distorted as the equalizer unit could not equalize it with the initial tap coefficients determined by the conventional method, the equalizer unit may equalize such extremely distorted signal and may recover the data signal.

Another aspect of the invention relates to an optical transceiver that includes a transmitter and a receiver to perform a full-duplex optical communication using a pair of multimode fibers each coupled with the transmitter and the receiver. The receiver includes an equalizer unit to equalize a distorted signal, which is transmitted through the multimode fiber and has a clock cycle of T seconds, such that the equalizer unit is provided with a set of tap coefficients and adjusts the tap coefficients. A feature of the invention is that the tap coefficients has an initial condition determined such that the equalizer unit equalizes a dummy signal with a clock cycle of k times T seconds, where k is an integer equal to or greater than 2.

### BRIEF DESCRIPTION OF DRAWINGS

FIG. 1 is a block diagram of the optical transceiver according to an embodiment of the inventions;

FIG. 2 is a block diagram of the equalizer unit comprised of the optical transceiver shown in FIG. 1;

FIG. 3A is an output waveform of the preamplifier for the transmission speed of 10 Gbps, and

FIG. 3B is an output waveform for the transmission speed of 20 Gbps;

FIG. 4A is an output waveform of the equalizer unit for the transmission speed of 10 Gbps, and

FIG. 4B is an output waveform for the transmission speed of 20 Gbps;

FIG. 5 is a flow chart of the equalizing procedure performed by the equalizer unit;

FIG. 6 shows an output waveform of the equalizer unit for the transmission speed of 20 Gbps, which is processed in accordance with the present invention; and

FIG. 7 shows a frequency response of the output of the equalizer unit initialized by the conventional procedure, the response of the output of the equalizer unit initialized in accordance with the present invention, and the output of the equalizer unit after the tap coefficients appropriately determined.

### DESCRIPTION OF PREFERRED EMBODIMENTS

Next, preferred embodiments according to the present invention will be described as referring to accompanying drawings. In the description of the drawings, the same elements will be referred by the same numerals or the same symbols without overlapping explanations.

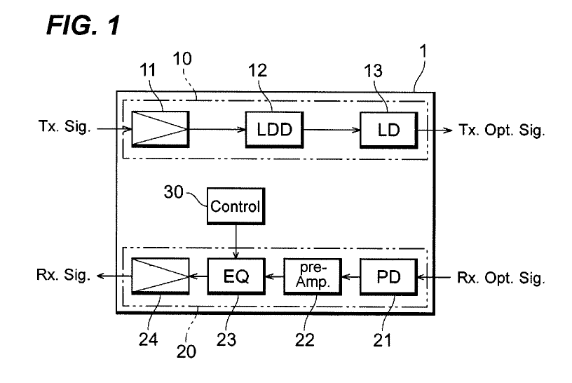

FIG. 1 shows a block diagram of an optical transceiver 1 according to the embodiment of the invention. The transceiver 1 shown in FIG. 1 is applicable to 10 GBASE-LRM, which is one standard of the optical communications, and includes a transmitter 10, a receiver 20, and a control unit 30.

The transmitter 10 includes a signal shaper 11, an LD driver 12 and an LD 13. The signal shaper 11 shapes, by receiving the input electrical signal Tx-Sig., outputs the shaped signal to the LD driver 12. The LD driver 12, by receiving the shaped signal from the signal shaper 11, drives the LD in the current mode. The signal shaper 11 is able to be omitted when the input electrical signal has only low frequency components, but is preferable to be provided when the transmission speed of the input signal exceeds and enters in a gigahertz region.

The receiver 20 includes a PD 21, a pre-amplifier 22, an equalizer unit 23 and a signal shaper 24. The PD 21, by receiving an optical signal from an external optical fiber, converts the optical signal into an electrical signal, a photocurrent, and output this electrical signal to the pre-amplifier 22. The pre-amplifier 22 amplifies this electrical signal so as to be processed in the downstream equalizer unit 23. When the electrical signal provided from the PD 21 is the photocurrent, the pre-amplifier 22 may convert this photocurrent into a voltage signal and amplify this voltage signal so as to be processed in the equalizer unit 23. The equalizer unit 23 equalizes the electrical signal provided from the pre-amplifier 22 so as to recover the data component and the clock component contained in the input optical signal by the signal shaper 24. The control unit 30 controls the equalizer unit 23, whose details will be described later.

The optical transceiver 1 thus configured is optically coupled with the other optical transceiver 2 providing the same configuration with the first transceiver 1 by a pair of optical fibers, that is, the LD 13 in the first transceiver 1 is coupled with the PD 21 in the second transceiver 2, while, the LD in the second transceiver 2 is coupled with the PD 21 in the first transceiver 1 with the second optical fiber. Thus, the full duplex communication between two transceivers may be accomplished.

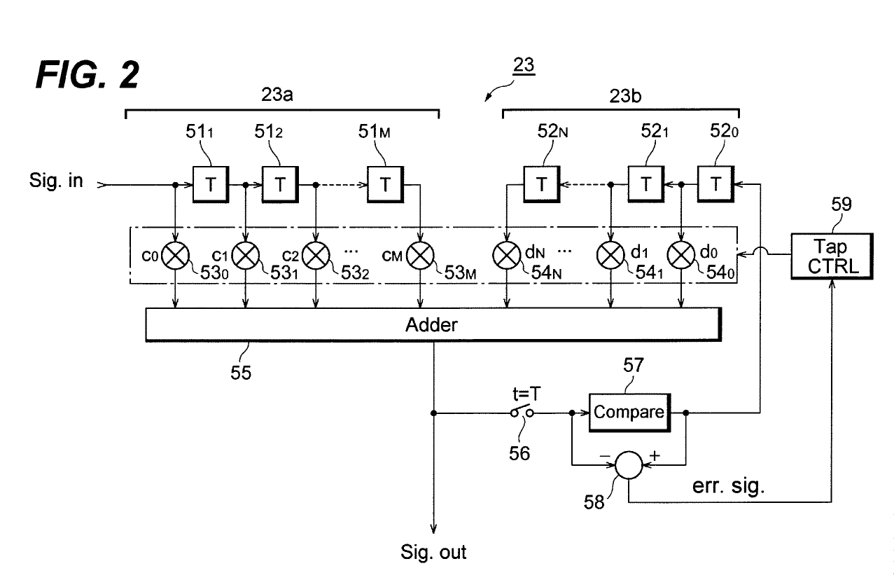

Next, the equalizer unit 23 provided in the receiver 20 will be described. FIG. 2 is a block diagram of the equalizer unit 23, which includes M stages of delay units, 51₁, to 51_{M}, N+1 stages of delay units, 52₀, to 52_{N}, M+l units of multiplies, 530 to 53_{M}, N+1 units of multipliers, 54₀ to 54_{N}, an adder 55, a sampler 56, a comparator 57, a subtractor 58 and a tap controller 59. Here, M and N are integers equal to or greater than 1, and the symbol m appeared below is an integer equal to or greater than 1 and equal to or smaller than M (1<=m<=M), while, the symbol n is an integer equal to or greater than 0 and equal to or smaller than N (0<=n<=N).

The delay units, 51ₗ,to 51_{M}, connected in series in this order, delays the input signal provided from the upstream unit by a time T. The input signal provided in the first delay unit 51 is the signal output by the preamplifier 22 shown in FIG. 1. The other delay units, 52₀ to 52_{N}, which are connected in series in this order, also delays the input signal provided from the upstream delay unit by the time T. The original input signal provided to the first delay unit 52₀ is the output of the comparator 57. The unit delay time T corresponds to the clock cycle contained in the original data to be transmitted from or supplied to the transceiver.

The first multiplier 53₀ multiplies the signal input to the equalizer unit 23 by the tap coefficient co and outputs the multiplied result to the adder 55. The intermediate multiplier 53ₘ multiplies the delayed signal provided from the upstream delay unit 51ₘ, by the tap coefficient cₘ and outputs the multiplied result to the adder 55. Similarly, the multiplier 54ₙ, multiplies the delayed signal provided from the upstream unit 52ₙ by the tap coefficient dₙ and outputs thus multiplied result to the adder 55. The adder 55 sums M+1 counts of the outputs of the multiplier, 53₀ to 53_{N}, and N+1 counts of the multiplier, 54₀ to 54_{N}.

The sampler 56 samples and holds the output of the adder 55 by the cycle time of T seconds. The comparator 57 compares the output of the sampler 56 with a preset reference to decide the logical level, that is, the comparator 57 decides whether the output of the sampler 56 is in the high level or in the low level. The subtractor 58, by subtracting the input of the comparator 57 from the output thereof, provides the subtracted result to the tap control 59 as an error signal. The tap control 59 adjusts the tap coefficients, c₀ to C_{M} and d₀ to d_{N}, so as to minimize the error signal. The delay units, 51 to 51_{M}, and the multipliers, 53₀ to 53_{M}, constitute the feed forward block 23a, while, the delay units, 52₀ to 52_{N}, the multipliers, 54₀ to 54_{N}, the sampler 56, the comparator 57 and the subtractor 58 constitute the feedback block 23b.

Such an equalizer unit is often called as the transversal filter which is one type of digital filters whose frequency response may be dynamically varied by setting the trap coefficients. That is, the equalizer unit 23 may provide an adequate filtering process by adjusting the tap coefficients, c₀ to c_{M} and d₀ to d_{N}, of respective multipliers even the input signal is strongly distorted due to the dispersion of the optical fiber. The equalizer unit 23 may only provide the feed forward block 23a to simplify their arrangement.

Usually, the tap coefficients are initially set such that one of coefficients, c₀ to C_{M} is set to 1, while, the rests are set to 0, and all coefficients, d₀ to d_{N}, in the feedback block 23b are set to 0. Receiving the optical signal with the distortion and providing electrical signal corresponding to the optical signal to the equalizer unit whose tap conditions are so set, the tap control 29 adjusts respective tap coefficients so as to minimize the error signal. When the characteristics of the optical fiber coupled with the PD 21 are known in advance and the tap coefficients derived from the characteristics of the fiber are also known, then, such tap coefficients maybe set as the initial condition. However, when the optical transceiver 1 is coupled with the already existing fiber with the multimode function, the dispersion characteristic thereof would be hard to know until the practical optical signal is transmitted there.

Recently, the optical transceiver 1 shown in FIG. 1 is to be applied to the communication system whose transmission speed reaches 20 Gbps. When the already existing fiber shows the dispersion of the pre-cursor type whose transmission bandwidth is restricted to merely 2.7 GHz, the degradation of the signal waveform with a speed of 20 Gbps becomes so large.

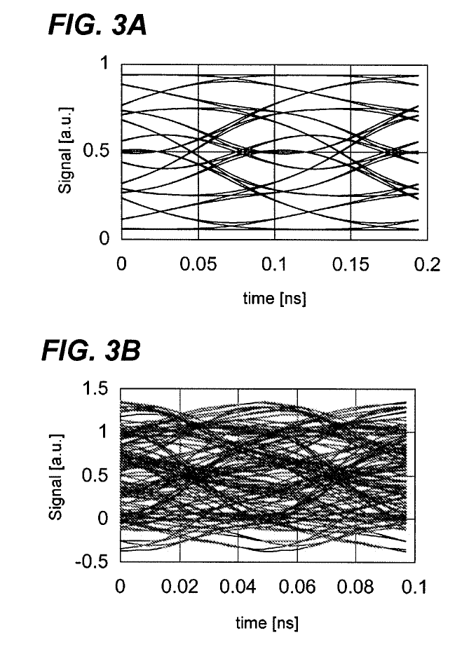

FIGS. 3A and 3B show examples of the voltage signal output from the pre-amplifier 22, which is a result practically obtained in a case where the optical fiber coupled with the PD 21 shows the dispersion of the pre-cursor type. FIG. 3A shows the result of the transmission speed of 10 Gbps, while, FIG. 3B corresponds to a result of the transmission speed of 20 Gbps. Although we may recognize a slight opening in the eye diagram in FIG. 3A; FIG. 3B does not show any opening that we could distinguish the data level, which means that, in the transmission speed of 20 Gbps, we can not recover the original data by setting the initial tap coefficients similar to the conventional procedure where one of the tap coefficients, c₀ to C_{M}, in the feed forward block 23a is set to 1, while, the rests are set to 0 and all tap coefficients, d₀ to d_{N}, in the feedback unit 23b are set to 0.

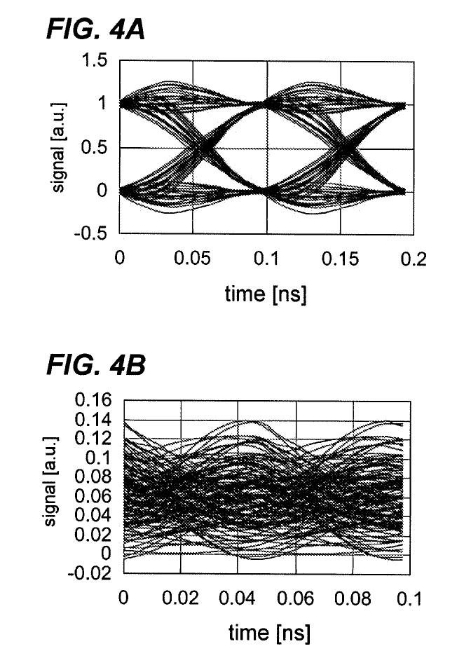

FIGS. 4A and 4B show the signal waveforms output from the equalizer unit 23 for the 10 Gbps transmission and for the 20 Gbps transmission, respectively. Here, the equalizer unit 23 is assumed to have 7 units of multipliers, 53₀ to 53₆ (M=6), in the feed forward block 23a, while 3 units of multipliers, 54₀ to 54₂ (N=2), in the feedback block 23b. The tap coefficients of these multiplier units are initially set such that, following the conventional procedures, only one of coefficients, c₀ to c₆, is set to 1, while, the rests are set to 0, and all coefficients, d₀ to d_{N}, in the feedback block 23b are set to 0. FIGS. 4A and 4B each shows, from the initial condition described above, the results after the equalizer unit 23 performs the equalization procedures. For the 10 Gbps transmission shown in FIG. 4A, the equalizer unit 23 may recover the original data, while, we could not recover the original data for the 20 Gbps transmission as shown in FIG. 4B. That is, in the 20 Gbps transmission, the signal input to the equalizer unit 23 is already influenced by the large distortion; it may be unable to recover it, or to obtain a best combination of tap coefficients, by the equalizing procedure from the initial tap coefficients set under the conventional method.

Therefore, an embodiment presently described improves the procedure to set the initial tap coefficients for the equalizer unit 23, which makes it possible to recover the original data, or to carry out the equalizing procedure by the equalizer unit 23. That is, the control unit 30 in the transceiver 1 inputs an electrical signal whose clock is k·T, where k is an integer equal to or greater than 2, to carry the equalizing procedure to get a best set of tap coefficients, which is the first step, and the transceiver 1 performs the equalizing procedure by the equalizing unit 23 for the practical signal with the clock period of T with thus evaluated tap coefficients above as the initial condition.

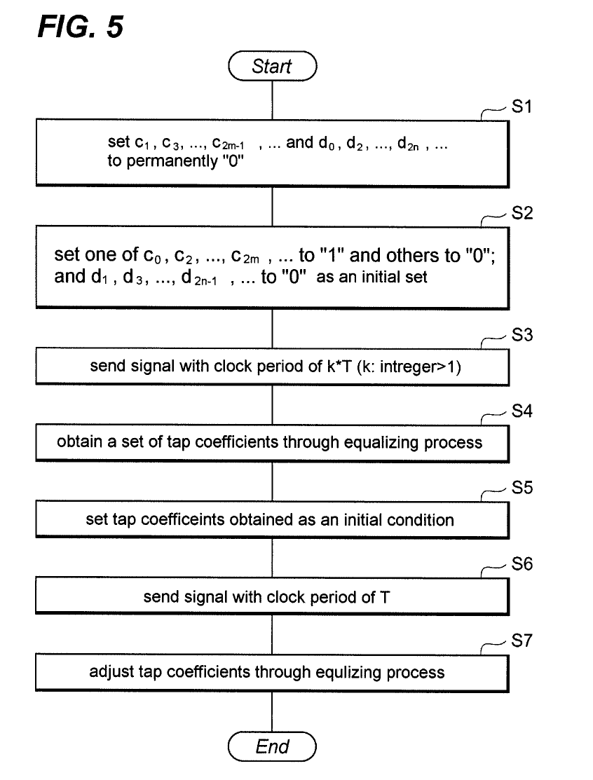

Next, the process to get the initial tap coefficients will be practically described. FIG. 5 is a flowchart showing the method according to the present invention. At step S1, odd orders of tap coefficients, c₁, C₃, . . . , c₂ₘ₋₁, . . . in the feed forward block 23a and even orders of tap coefficients, d₀, d₂, . . . , d₂ₙ, . . . in the feedback block 23bare temporarily set to 0. At step S2, one of even orders of tap coefficients, c₀, c₂, . . . , c₂ₘ, . . . is set to 1, while the rests are set to 0, and odd orders of tap coefficients, d₁, d₃, . . . , d₂ₙ₋₁, . . . are set to 0, which is the first initial condition of the tap coefficients. At step S3, the equalizer unit 23 receives a dummy signal that contains levels always continuing two bits, for instance 1100111100, which has a half transmission speed of the fundamental speed of the data to be practically transmitted. At step S4, the equalizer unit 23 carries out the equalizing procedure for such a signal and gets the best set of the tap coefficients to minimize the error signal. At step S5, the equalizer unit 23 sets the tap coefficients thus obtained for the half rate of the clock as the initial condition of the signal with the fundamental clock speed. Lastly, at steps S6 and S7, the transceivers 1 receives the practical signal with the fundamental clock speed and the equalizer unit 23 carries the equalizing procedure to revise the tap coefficients.

As an example, the control unit 30 sets the tap coefficients, C₁, C₃, C₅, d₀ and d₂ equal to 0 at step S1, and sets c₀=1 at step S2. The equalizing unit 23 receives the signal whose transmission speed is 10 Gbps and contains the dispersion of the pre-cursor type at step S3, and subsequently, the unit 23 performs the equalizing procedure for such a signal to converge the tap coefficients, c₀, c₂, C₄, c₆, and d₁, at step S4. Practical values of the tap coefficients above are, c₀=0.2989, c₂=−1.386, c₄=2.7118, c₆=−0.0247 and d₁=−0.4053, which makes the diagram to open an enough eye as shown in FIG. 4A.

At step S4, the control unit 30 sets the initial tap coefficients of c₀=0.2989, c₂=−1.386, c₄=2.7118, c₆=−0.0247, d₁=−0.4053, which are obtained at step S3, and sets other coefficients to 0 as the initial condition of the equalizer unit 23. Finally, at steps S6 and S7, the transceiver 1 receives the practical optical signal, which is the transmission speed of 20 Gbps and is influenced by the enough dispersion and carries the equalizing procedure to revise and to adjust all tap coefficients, c₀ to c₆ and d₀ to 1.

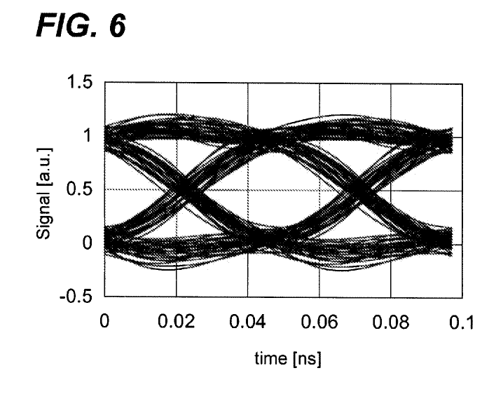

In the present embodiment, even the equalizer unit 23 sets the initial tap coefficients determined at step S5, the output of the equalizer unit 23 appears shut eyes for the signal with the transmission speed of 20 Gbps, but the degradation becomes small compared with the case where only one tap coefficient is initially set to 1. Accordingly, the equalizer unit 23 may effectively recover the original data as shown in FIG. 6, which is the output waveform of the equalizer unit 23. Comparing FIG. 6 with FIG. 4B, the case where only one tap coefficient is set to 1, could not recover the original data, while, FIG. 6 clearly shows that the original data is effectively recovered.

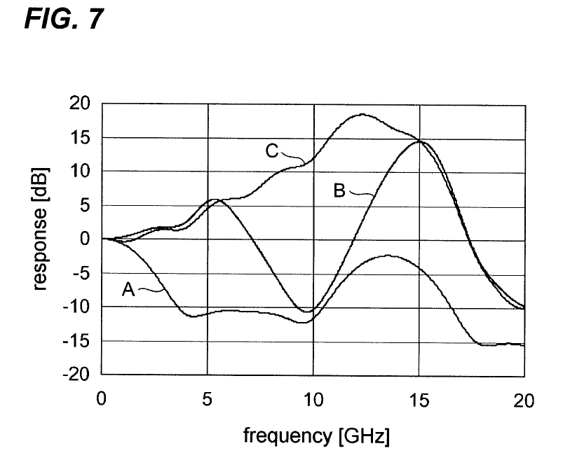

A reason why FIG. 4B could not recover the data while FIG. 6 appropriately reproduces the original may be explained in FIG. 7 which shows the frequency responses of the equalizer unit 23. Assuming that the optical fiber is an multimode fiber showing the dispersion of the pre-cursor type and the receiver 20 receives an optical signal from this multimode fiber through the preamplifier with a bandwidth of 15 GHz (=20×0.75) approximated by the Bessel filter, the frequency response of the receiver 20 superposed with the multimode fiber becomes a behavior A in FIG. 7, that is, the frequency bandwidth thereof measured at −3 dB point becomes around 2 GHz.

When the equalizer unit 23 is operated at a half speed to the practical signal, that is, the equalizer unit 23 processes the signal with the 10 Gbps speed, the combined frequency response of the multimode fiber, the pre-amplifier and the equalizer unit 23 becomes a behavior B, whose frequency bandwidth expands up to 7.5 GHz at −3 dB point. Therefore, FIG. 4B correspond to a case that the equalizer unit 23 processes the signal with the 20 Gbps transmission speed at a condition of the frequency bandwidth thereof merely 2 GHz, while, FIG. 6 indicates that the equalizer unit 23 operates for the signal with 20 Gbps transmission speed at the frequency bandwidth of 7.5 GHz, which effectively converges the tap coefficients and adequately widens the eye. The behavior C in FIG. 7 indicates the total frequency response of the multimode fiber, the pre-amplifier and the equalizer unit 23 operating for the signal with 20 Gbps, that is, the frequency response thereof after the equalizer unit appropriately determines its tap coefficients.

Thus, according to the present invention, the tap coefficients of the equalizer unit may be effectively and appropriately determined for the input signal with the transmission speed over 20 Gbps even the optical fiber has the large dispersion for such a high speed signal.

A few preferred embodiments have been described in detail hereinabove. It is to be understood that the scope of the invention also comprehends embodiments different from those described, yet within the scope of the claims. Words of inclusion are to be interpreted as non-exhaustive in considering the scope of the invention.

What is claimed is:

1. A method to equalize, by an equalizer unit, a distorted signal transmitted through an optical fiber with dispersion, said distorted signal with a clock cycle of T second, comprising steps of:
providing a dummy signal with a clock cycle of k times T seconds, where k is an integer equal to or greater than 2, to said equalizer unit;
equalizing said dummy signal to obtain a set of tap coefficients of said equalizer unit; and
equalizing said distorted signal as said tap coefficients as an initial set.

2. The method according to claim 1,
wherein said equalizer unit includes a feed forward unit and a feedback unit,
wherein said step for equalizing said dummy signal includes a step for equalizing in an initial condition where one of tap coefficients of said feed forward unit is set to 1, and rests of tap coefficients of said feed forward unit and all of tap coefficients of said feedback unit are set to 0.

3. An optical transceiver including a transmitter and a receiver each coupled with respective multimode fibers, said receiver comprising an equalizer unit to equalize a distorted signal that is transmitted through said multimode fiber and has a clock cycle of T seconds, said equalizer unit equalizing said distorted signal by being provided with a set of tap coefficients and by adjusting said provided tap coefficients,
characterizer in that;
said tap coefficients has an initial condition determined such that said equalizer unit equalizes a dummy signal with a clock cycle of k times T seconds, where k is an integer equal to or greater than 2.
